(19) United States
(12) Patent Application Publication
(10) Pub. No.: US 2022/0038582 A1
(43) Pub. Date: Feb. 3, 2022

(54) DIAGNOSIS OF NETWORK ENVIRONMENT BETWEEN IMAGE FORMING DEVICE AND DIAGNOSTIC DEVICE

(71) Applicant: Hewlett-Packard Development Company, L.P., Spring, TX (US)

(72) Inventor: Hyun-wook PARK, Seongnam-si (KR)

(21) Appl. No.: 17/277,391

(22) PCT Filed: Jul. 29, 2019
(86) PCT No.: PCT/US2019/043905

§ 371 Date: Mar. 18, 2021

(30) Foreign Application Priority Data
Jan. 17, 2019 (KR) 10-2019-0006101

(51) Int. Cl. H04N 1/00; H04L 12/26

(52) U.S. Cl. CPC H04N 1/00029; H04L 43/065; H04N 1/00074; H04N 1/0001; H04L 43/10

(57) ABSTRACT

An example diagnostic apparatus includes a user interface device, a communication interface, a processor, and a memory storing instructions executable by the processor. The processor executes the instructions to receive, through the communication interface, a response packet in response to a network performance measurement packet transmitted to an image forming apparatus, determine a network performance between the image forming apparatus and a diagnostic apparatus based on network performance information measured based on the received response packet and reference network performance information corresponding to the image forming apparatus, and provide the determined network performance through the user interface device.

### BACKGROUND

An image forming apparatus and an external apparatus may be connected through a network to communicate with each other. For example, the external apparatus may request a print operation of the image forming apparatus, and the image forming apparatus may respond to the request of the external apparatus. A network environment between the image forming apparatus and the external apparatus may greatly affect the control of the image forming apparatus or the performance of the image forming apparatus. Diagnosing the network environment may facilitate the control of the image forming apparatus.

### BRIEF DESCRIPTION OF DRAWINGS

Various examples will be described below by referring to the following figures:

FIG. 1 is a diagram illustrating a network environment between an image forming apparatus and a diagnostic apparatus according to an example;

FIG. 2 is a block diagram illustrating a configuration of an image forming apparatus and a diagnostic apparatus according to an example;

FIG. 3 is a diagram illustrating an operation of a processor of an image forming apparatus according to an example;

FIG. 4 is a diagram illustrating a network performance measurement packet (i.e., a packet for network performance measurement) according to an example;

FIG. 5 is a diagram illustrating an operation of a processor of a diagnostic apparatus according to an example;

FIG. 6 is a diagram illustrating a diagnosis result provided by a diagnostic apparatus according to an example;

FIG. 7 is a flowchart illustrating an operation of an image forming apparatus and a diagnostic apparatus for diagnosing a network environment between the image forming apparatus and the diagnostic apparatus according to an example;

FIG. 8 is a flowchart illustrating an operation of an image forming apparatus and a diagnostic apparatus for diagnosing a network performance between the image forming apparatus and the diagnostic apparatus according to an example;

FIG. 9 is a flowchart illustrating an operation of an image forming apparatus and a diagnostic apparatus for scanning a network port blocked by a firewall in a network between the image forming apparatus and the diagnostic apparatus according to an example; and

FIG. 10 is a flowchart illustrating an operation of an image forming apparatus and a diagnostic apparatus for diagnosing a network quality between the image forming apparatus and the diagnostic apparatus according to an example.

### DETAILED DESCRIPTION OF EXAMPLES

Hereinafter, various examples will be described with reference to the drawings. In the specification and drawings, like reference numerals may denote like elements having substantially the same functions and configurations, and redundant descriptions thereof may be omitted for conciseness.

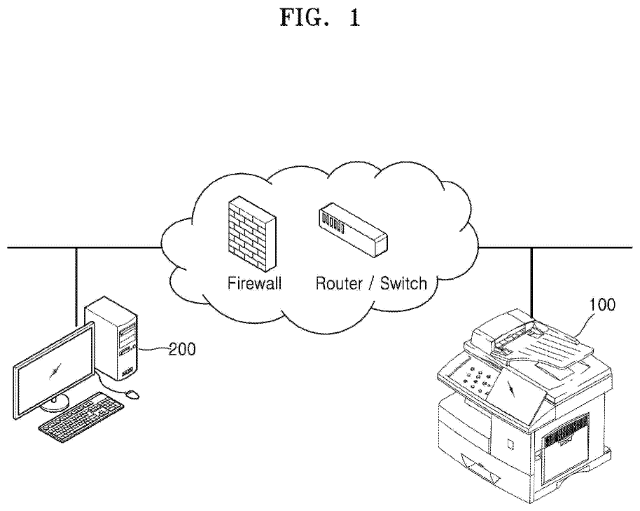

FIG. 1 is a diagram illustrating a network environment between an image forming apparatus and a diagnostic apparatus according to an example.

Referring to FIG. 1, the image forming apparatus 100 may be a printer, a copier, a scanner, a facsimile, or a multi-function peripheral (MFP) implementing functions of the above and may perform an image forming operation such as copying, printing, scanning, or faxing. The image forming apparatus 100 may form an image on a recording medium such as printing paper according to various printing methods according to the type thereof. For example, the printing methods of the image forming apparatus 100 may include an electrophotographic method, an inkjet method, a thermal transfer method, a direct thermal method, and the like.

The diagnostic apparatus 200 may be a computing apparatus such as a personal computer (PC), a notebook computer, a mobile device, and the like and may diagnose an environment of a network connecting the diagnostic apparatus 200 and the image forming apparatus 100. A user may communicate with the image forming apparatus 100 by using the diagnostic apparatus 200 and control an operation of the image forming apparatus 100 or monitor a state of the image forming apparatus 100.

As illustrated in FIG. 1, a network between the image forming apparatus 100 and the diagnostic apparatus 200 may include a combination of various network connection apparatuses. For example, the network connection apparatuses may include a router, a switch, a firewall, or various other apparatuses, and the combination of the network connection apparatuses for forming the network may vary. The router or the switch may transmit network diagnosis packets to the image forming apparatus 100, and the firewall may block a packet among the network diagnosis packets that is not allowed by a security policy.

The diagnostic apparatus 200 may be provided with a network diagnosis program to diagnose the environment of the network connecting the diagnostic apparatus 200 and the image forming apparatus 100 and provide a diagnosis result. The network diagnosis program may be a program for diagnosing the network environment connected to the image forming apparatus 100 by communicating with the image forming apparatus 100 through the network. The network diagnosis program may generate a network diagnosis packet (i.e., a packet for network diagnosis), transmit the network diagnosis packet to the image forming apparatus 100, and may receive a response packet from the image forming apparatus 100 to diagnose the network environment. The diagnosis of the network environment may consider such variables as a network quality, a network performance, a network port blocked by the firewall, and the like. The image forming apparatus 100 may include a network diagnosis module to perform a response corresponding to the request of the network diagnosis program installed in the diagnostic apparatus 200. The network diagnosis module may be a software function that may be embedded in the firmware of the image forming apparatus 100 or may be additionally installed as a plug-in. The network diagnosis module may receive a network diagnosis packet and perform a certain process according to the request included in the network diagnosis packet.

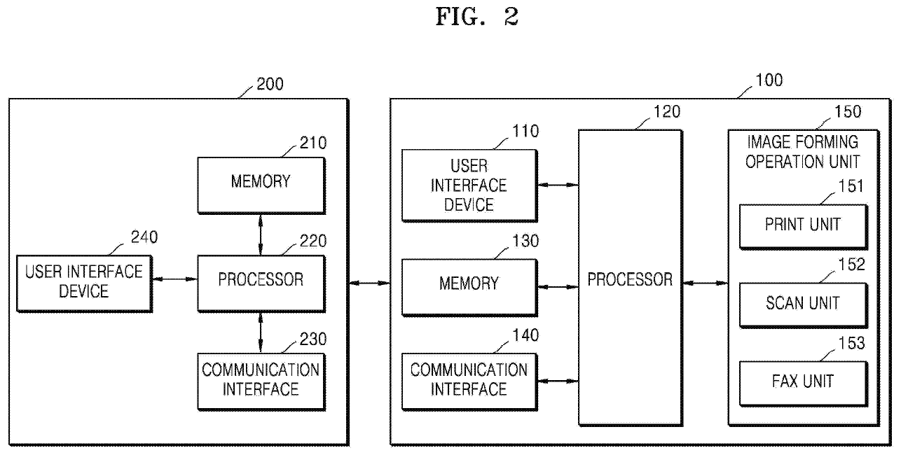

FIG. 2 is a block diagram illustrating a configuration of an image forming apparatus and a diagnostic apparatus according to an example.

Referring to FIG. 2, the image forming apparatus 100 may include a user interface device 110, a processor 120, a memory 130, a communication interface 140, and an image forming operation unit 150. Also, although not illustrated, the image forming apparatus 100 may further include a power supply unit for supplying power to the respective components.

The user interface device 110 may include an input unit for receiving an input or the like for performing an image forming operation from a user and an output unit for displaying information about the result of the image forming operation or a state of the image forming apparatus 100. For example, the user interface device 110 may be in the form of a touch screen including an operation panel for receiving a user input and a display panel for displaying a screen.

The processor 120 may control operations of the image forming apparatus 100 and may include at least one processing unit such as a central processing unit (CPU). The processor 120 may control other components included in the image forming apparatus 100 to perform an operation corresponding to a user input received through the user interface device 110. The processor 120 may include at least one specialized processing unit corresponding to each function or may be in the form of a single integral unit.

The processor 120 may execute a program stored in the memory 130, read data or files stored in the memory 130, or store a new file in the memory 130. The memory 130 may store instructions executable by the processor 120.

The memory 130 may store various types of data such as files or programs such as applications. The processor 120 may use data stored in the memory 130 or may store new data in the memory 130. Also, the processor 120 may execute a program or an application installed in the memory 130.

The communication interface 140 may perform wired/wireless communication with another device or a network. The communication interface 140 may include a communication module (e.g., transceiver) that supports at least one of various wired/wireless communication methods. The wireless communication may include, for example, Wireless Fidelity (Wi-Fi), Wi-Fi Direct, Bluetooth, Ultra-Wide Band (UWB), Near Field Communication (NFC), and the like. The wired communication may include, for example, Ethernet, Universal Serial Bus (USB), High Definition Multimedia Interface (HDMI), and the like.

The communication interface 140 may be connected to an electronic apparatus located outside the image forming apparatus 100 to transmit/receive signals or data thereto/therefrom. The communication interface 140 may transmit signals or data received from the external apparatus to the processor 120 or may transmit signals or data generated by the processor 120 to the external apparatus. For example, when the communication interface 140 receives a print command signal and a print operation target from the external apparatus, the processor 120 may output the received print operation object through a print unit 151.

The image forming operation unit 150 may perform an image forming operation such as copying, printing, scanning, or faxing. As illustrated in FIG. 2, the image forming operation unit 150 may include the print unit 151, a scan unit 152, and a fax unit 153. However, when necessary, the image forming operation unit 150 may include only some of these components or may further include other components for performing other types of image forming operations. The image forming operation unit 150 may perform an image forming operation according to a command obtained by reconstructing a user input through the user interface device 110 on a main control board. The print unit 151 may form an image on a recording medium by various print methods such as an electrophotographic method, an inkjet method, a thermal transfer method, a direct thermal method, and the like. The scan unit 152 may irradiate light onto a manuscript and receive reflected light to read an image recorded on the manuscript. The fax unit 153 may share a configuration for scanning an image with the scan unit 152, share a configuration for printing a received file with the print unit 151, and transmit a scan file to a destination or receive a file from an external source.

The diagnostic apparatus 200 may include a memory 210, a processor 220, a communication interface 230, and a user interface device 240. The diagnostic apparatus 200 may be an apparatus for diagnosing the network environment between the image forming apparatus 100 and the diagnostic apparatus 200.

The memory 210 may store instructions executable by the processor 220. The memory 210 may store an operating system and application programs.

The processor 220 may control operations of the diagnostic apparatus 200 and may include at least one processing unit such as a CPU. The processor 220 may control other components included in the diagnostic apparatus 200 to perform an operation corresponding to a user input received through the user interface device 240. The processor 220 may include at least one specialized processing unit corresponding to each function or may be in the form of a single integral unit. The processor 220 may execute a program stored in the memory 210, read data or information stored in the memory 210, or store new data or information in the memory 210.

The communication interface 230 may request the image forming apparatus 100 for information required to diagnose the network environment and receive a response to the request from the image forming apparatus 100.

The user interface device 240 may include an input unit for receiving an input, such as an input for network environment diagnosis, or information about the image forming apparatus 100, and an output unit for displaying information such as network environment diagnosis results.

The names of the components of the image forming apparatus 100 or the diagnostic apparatus 200 described above may vary according to various examples.

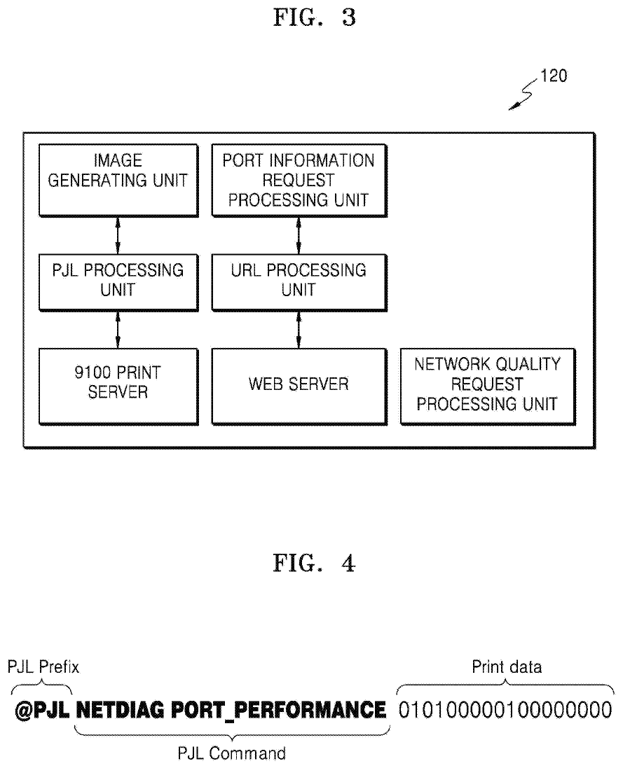

FIG. 3 is a diagram illustrating an operation of a processor of an image forming apparatus according to an example.

Referring to FIG. 3, the processor 120 of the image forming apparatus 100 may execute instructions stored in the memory 130 to perform the following operations.

The processor 120 may receive a network diagnosis packet from the diagnostic apparatus 200 through the communication interface 140, analyze the received network diagnosis packet to determine the request of the diagnostic apparatus 200 for diagnosing the network environment between the image forming apparatus 100 and the diagnostic apparatus 200, and perform a certain process according to a result of the determination.

For example, when the network diagnosis packet is a network performance measurement packet (i.e., a packet for network performance measurement) including print data and information indicating that it is for network performance measurement, the processor 120 may receive the network performance measurement packet through a print server port through the communication interface 140. The information indicating that the network diagnosis packet is for network performance measurement may be in the form of a Print Job Language (PJL) command. However, the information is not limited thereto. The processor 120 may transmit, to the diagnostic apparatus 200, a response packet indicating that the network performance measurement packet has been received.

FIG. 4 is a diagram illustrating a network performance measurement packet (i.e., a packet for network performance measurement) according to an example.

Referring to FIG. 4, the network performance measurement packet may be parsed into a header and a payload. The header may include a PJL prefix and a PJL command, and the payload may include print data. In the case of FIG. 4, the PJL command may indicate that the print data included in the payload is dummy data for network performance measurement.

Referring back to FIG. 3, the processor 120 may determine the request of the diagnostic apparatus 200 according to the information indicating that it is for network performance measurement, which is included in the received network performance measurement packet, delete the print data without performing an image forming operation on the print data in the case that the network performance measurement packet includes information indicating that it is for network performance measurement, and perform an image forming operation on the print data in the case that the network performance measurement packet includes information indicating that it is not for network performance measurement. For example, the processor 120 may determine the request of the diagnostic apparatus 200 according to the type of the PJL command included in the received network performance measurement packet, delete the print data without performing an image forming operation on the print data when the type of the PJL command is a PJL command for network performance measurement, and perform an image forming operation on the print data when the type of the PJL command is not a PJL command for network performance measurement.

As another example, when the network diagnosis packet includes a list request of opened network ports in the image forming apparatus 100 or a connection request for each network port included in the list of opened network ports, the processor 120 may receive, through the communication interface 140, the list request of opened network ports in the image forming apparatus 100 through a web server port and receive the connection request for each network port included in the list of opened network ports through each network port. The processor 120 may determine whether it is the list request of opened network ports in the image forming apparatus 100 or the connection request for each network port included in the list of opened network ports. The processor 120 may transmit a list of opened network ports in the image forming apparatus 100 collected by the image forming apparatus 100 to the diagnostic apparatus 200 through the communication interface 140 in the case of being the list request of opened network ports in the image forming apparatus 100. Also, the processor 120 may transmit a response packet in response to the connection request for each port to the diagnostic apparatus 200 through the communication interface 140 in the case of being the connection request for each port included in the list of opened network ports.

Referring to FIG. 3, the processor 120 of the image forming apparatus 100 may include a plurality of modules for performing certain functions. As illustrated in FIG. 3, the processor 120 may include a 9100 print server, a PJL processing unit, an image generating unit, a web server, a URL processing unit, a port information request processing unit, and a network quality request processing unit. In order to describe the function of the processor 120, for convenience of description, the processor 120 is divided into modules as illustrated in FIG. 3. However, the processor 120 is not limited to such divisions or names.

The 9100 print server may be a server module that opens a TCP 9100 port to receive data (e.g., print data). The 9100 print server may receive data from an external source through the network and transmit the received data to the PJL processing unit.

The PJL processing unit may parse the received data into a header and a payload and analyze a portion corresponding to the header. The PJL processing unit may identify information about an operation according to the PJL command included in the header and transmit a print data portion included in the payload to the image generating unit. However, when the type of the PJL command is for network performance measurement, the print data may be deleted and not transmitted to the image generating unit. The PJL processing unit may correspond to an example of a module that determines the request of the diagnostic apparatus 200 according to information indicating that it is for network performance measurement, which is included in the received network performance measurement packet, and performs a certain process according to the determination result.

The image generating unit may process the print data to generate an image.

The web server may open a TCP 80 or TCP 431 port and receive and process a request transmitted from an external web client. The request received by the web server may be transmitted to the URL processing unit according to each requested URL.

The URL processing unit may receive the request from the web server and transmit the received request to a processing unit for each URL.

The port information request processing unit may receive a list request of opened network ports in the image forming apparatus 100, collect information of opened network ports in the image forming apparatus 100, generate a list of opened network ports, and respond to the list request of opened network ports.

The network quality request processing unit may receive and respond to a network quality measurement packet (i.e., a packet for network quality measurement).

The processor 120 of the image forming apparatus 100 may further include various service/server modules such as discovery services (MDNS, WINS, UPnP, and SSDP) and print services (IPP, LPD, and WSD).

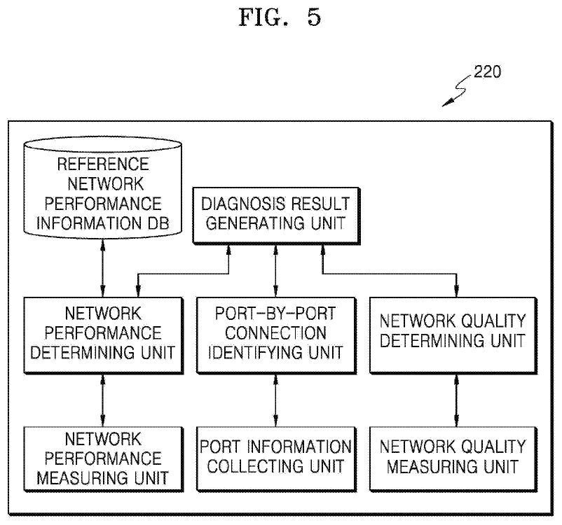

FIG. 5 is a diagram illustrating an operation of a processor of a diagnostic apparatus according to an example.

Referring to FIG. 5, the processor 220 of the diagnostic apparatus 200 may execute instructions stored in the memory 210 to perform the following operations.

The processor 220 may receive a response packet corresponding to a network diagnosis packet from the image forming apparatus 100 through the communication interface 230 in response to the network diagnosis packet transmitted to the image forming apparatus 100, diagnose the network environment between the image forming apparatus 100 and the diagnostic apparatus 200 based on the response packet received from the image forming apparatus 100, and provide a diagnosis result through the user interface device 240.

For example, when the network diagnosis packet is a network performance measurement packet (i.e., a packet for network performance measurement) including print data and information indicating that it is for network performance measurement, the processor 220 may receive a response packet through the communication interface 230 in response to the network performance measurement packet transmitted to a print server port of the image forming apparatus 100. The processor 220 may determine the network performance between the image forming apparatus 100 and the diagnostic apparatus 200 based on the network performance information measured based on the received response packet and reference network performance information corresponding to the image forming apparatus 100 stored in the diagnostic apparatus 200.

As another example, when the network diagnosis packet includes a list request of opened network ports in the image forming apparatus 100 or a connection request for each network port included in the list of opened network ports, the processor 220 may receive, through the communication interface 230, a list of opened network ports from the image forming apparatus 100 in response to the list request of opened network ports transmitted to a web server port of the image forming apparatus 100 and receive a response packet indicating whether each network port is connected in response to the connection request for each network port transmitted to each network port included in the list of opened network ports. The processor 220 may identify a list of connected network ports among the respective network ports included in the list of opened network ports, based on the received response packet and scan a network port blocked by the firewall, based on the list of opened network ports and the list of connected network ports.

The processor 220 may provide, through the user interface device 240, a network performance report indicating whether the network performance is at a level suitable to use the image forming apparatus 100 or a port scan report indicating the network port blocked by the firewall.

As illustrated in FIG. 5, the processor 220 of the diagnostic apparatus 200 may be configured to include a plurality of modules for performing certain functions. For example, the processor 220 may include a network performance measuring unit, a network performance determining unit, a port information collecting unit, a port-by-port connection identifying unit, a network quality measuring unit, a network quality determining unit, and a diagnosis result generating unit. For convenience of description, the processor 220 is divided into modules as illustrated in FIG. 5. However, the processor 220 is not limited to such divisions or names.

The network performance measuring unit may measure the network performance by transmitting data from the diagnostic apparatus 200 to the image forming apparatus 100. The network performance measuring unit may generate a network performance measurement packet by including information indicating that it is for network performance measurement, for example, a PJL command, in the header portion of the data, transmit the network performance measurement packet to the TCP 9100 port of the image forming apparatus 100, and measure the network performance information by measuring an amount of transmitted data and the transmission time thereof.

The network performance determining unit may determine the network performance between the image forming apparatus 100 and the diagnostic apparatus 200 based on the measured network performance information and reference network performance information corresponding to the image forming apparatus 100 stored in the diagnostic apparatus 200. The reference network performance information corresponding to the image forming apparatus 100 may include the maximum network speed of the image forming apparatus 100.

A reference network performance information database (DB) may store reference network performance information corresponding to each model of the image forming apparatus 100. Since the measurement value of the network performance information may vary according to the communication interface performance and the CPU performance of the image forming apparatus 100, the reference network performance information corresponding to each model of the image forming apparatus 100 may be prepared and updated at certain periods.

The port information collecting unit may request the image forming apparatus 100 for a list of opened network ports in the image forming apparatus 100 and receive the list of opened network ports from the image forming apparatus 100.

Based on the list of opened network ports collected by the port information collecting unit, the port-by-port connection identifying unit may attempt a connection to each network port included in the list to identify the connection or non-connection thereof and generate a list of connected network ports. The port-by-port connection identifying unit may compare the list of opened network ports to the list of connected network ports to determine a network port blocked by the firewall. The port-by-port connection identifying unit may determine, as a blocked network port, a network port that is identified as an opened network port in the image forming apparatus 100 but is not actually connected.

The network quality measuring unit may transmit a network quality measurement packet to the image forming apparatus 100 and measure network quality information such as a packet loss rate or a response time based on the response packet replied by the image forming apparatus 100.

The network quality determining unit may determine whether the network quality is suitable to support use of the image forming apparatus 100, based on the network quality information measured by the network quality measuring unit.

The diagnosis result generating unit may generate a network environment diagnosis result as a report based on the respective determination results of the network performance determining unit, the port-by-port connection identifying unit, and the network quality determining unit.

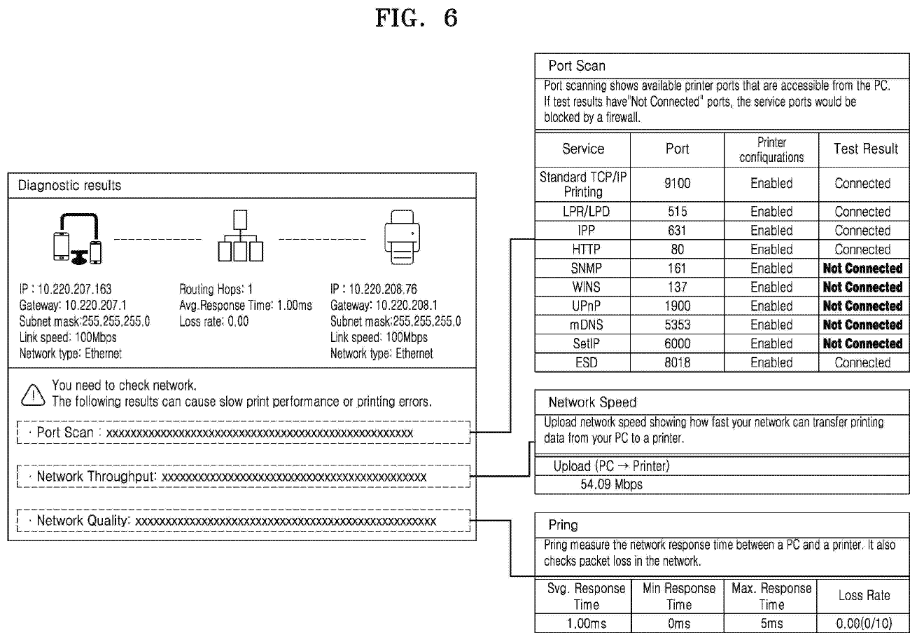

FIG. 6 is a diagram illustrating a diagnosis result provided by a diagnostic apparatus according to an example.

Referring to FIG. 6, the diagnostic apparatus 200 may provide a network environment diagnosis result through the user interface device 240. The diagnosis result may include a review of the network port scan result, the network performance, and the network quality. In an example, the diagnostic apparatus 200 may provide, through the user interface device 240, a port scan report indicating a network port blocked by the firewall, a network performance report indicating whether the network performance is at a level suitable for use of the image forming apparatus 100, and a network quality report indicating a network quality such as a delay time and a loss rate of the network quality measurement packet.

The port scan report may identify a list of network ports blocked by the firewall. The diagnostic apparatus 200 may identify the list of network ports blocked by the firewall by distinguishing a list of network ports connected to the diagnostic apparatus 200 from the list of opened network ports in the image forming apparatus 100. According to the information received from the image forming apparatus 100, the network ports of the respective services illustrated in FIG. 6 are determined as being opened in the image forming apparatus 100. However, as a result of the identifying, by the diagnostic apparatus 200, connected service ports by making a connection request for the respective service network ports in the image forming apparatus 100, it may be seen that service network ports such as SNMP, WINS, UPnP, mDNS, and SetIP are not actually connected. That is, it may be seen that the service network ports such as SNMP, WINS, UPnP, mDNS, and SetIP are network ports blocked by the firewall. Accordingly, the user may view the port scan report and modify the firewall settings.

The network performance report may indicate whether the network performance between the image forming apparatus 100 and the diagnostic apparatus 200 is at a level suitable for use of the image forming apparatus 100. The diagnostic apparatus 200 may determine the network performance between the image forming apparatus 100 and the diagnostic apparatus 200 based on the network performance information measured by the diagnostic apparatus 200 and the reference network performance information corresponding to the image forming apparatus 100 stored in the diagnostic apparatus 200. For example, when the measured network performance information is the network speed at the time of uploading from the diagnostic apparatus 200 to the image forming apparatus 100, the diagnostic apparatus 200 may determine the level of the network performance by comparing the measured network speed to the maximum network speed of the image forming apparatus 100. As illustrated in FIG. 6, when the network speed at the time of uploading from a PC as the diagnostic apparatus 200 to the image forming apparatus 100 is 54.09 Mbps, the diagnostic apparatus 200 may compare the prestored maximum network speed of the image forming apparatus 100 to the measured network speed of 54.09 Mbps and inform the user what percentage (%) the level corresponds to. Accordingly, the user may view the network performance report and determine whether the network connected to the image forming apparatus 100 is suitable for use of the image forming apparatus 100.

The network quality report may indicate the network quality such as the delay time and the loss rate of the packet transmitted to the image forming apparatus 100. The diagnostic apparatus 200 may determine the network quality based on the reception of the response packet according to the transmission of the network quality measurement packet. The diagnostic apparatus 200 may repeatedly transmit the network quality measurement packet to the image forming apparatus 100 at certain periods and receive the response packet from the image forming apparatus 100. The diagnostic apparatus 200 may measure the number of received response packets and the time taken to receive the response packets and inform the user of information about the average response time, the minimum response time, the maximum response time, and the loss rate thereof.

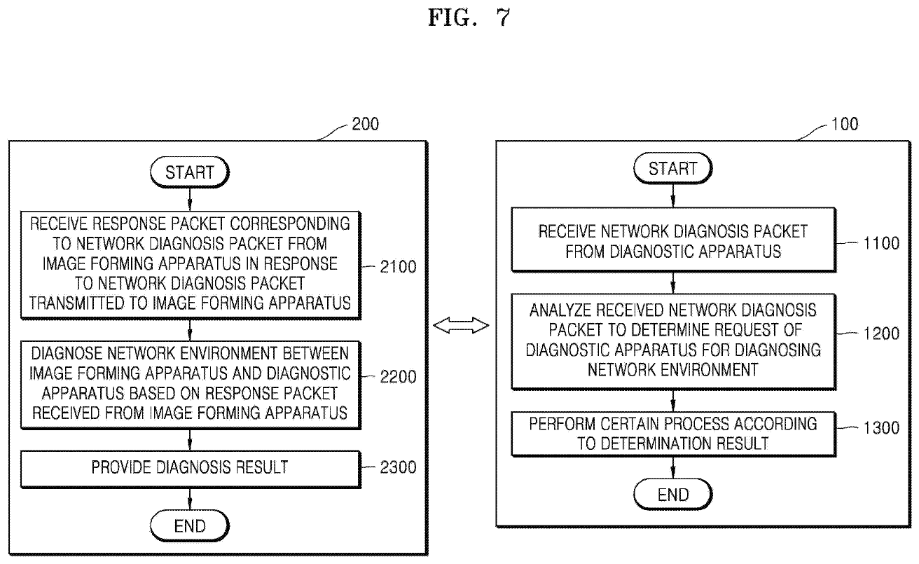

FIG. 7 is a flowchart illustrating an operation of an image forming apparatus and a diagnostic apparatus for diagnosing a network environment between the image forming apparatus and the diagnostic apparatus according to an example.

Referring to FIG. 7, the network environment between the image forming apparatus 100 and the diagnostic apparatus 200 may be diagnosed by executing a network diagnosis program in the diagnostic apparatus 200, selecting a network environment diagnosis, and selecting the image forming apparatus 100 corresponding to a target to be diagnosed. Alternatively, by displaying an option for performing a network environment diagnosis in a confirmation menu after completion of installation of a installer driver in the image forming apparatus 100, the network environment diagnosis may be performed according to the user's selection together with identifying whether the installation of the image forming apparatus 100 is normally completed.

In operation 2100, the diagnostic apparatus 200 may receive a response packet corresponding to a network diagnosis packet from the image forming apparatus 100 in response to the network diagnosis packet transmitted to the image forming apparatus 100.

In operation 2200, the diagnostic apparatus 200 may diagnose the network environment between the image forming apparatus 100 and the diagnostic apparatus 200 based on the response packet received from the image forming apparatus 100.

In operation 2300, the diagnostic apparatus 200 may provide the diagnosis result.

In response to the operation of the diagnostic apparatus 200, in operation 1100, the image forming apparatus 100 may receive the network diagnosis packet from the diagnostic apparatus 200.

In operation 1200, the image forming apparatus 100 may analyze the received network diagnosis packet to determine a request of the diagnostic apparatus 200 for diagnosing the network environment between the image forming apparatus 100 and the diagnostic apparatus 200.

In operation 1300, the image forming apparatus 100 may perform a certain process according to the determination result.

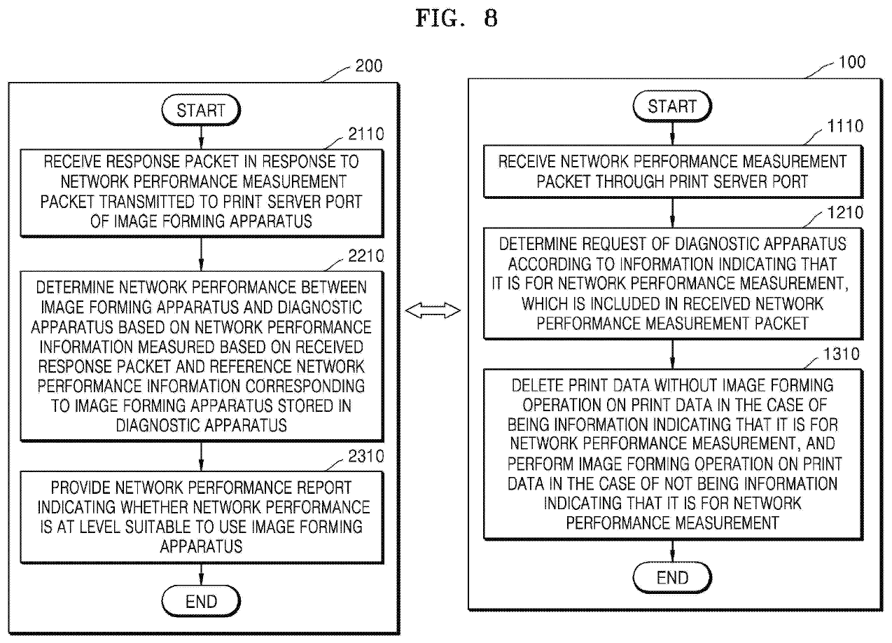

Hereinafter, examples of diagnosing the network environment, network performance diagnosis, scanning of a network port blocked by the firewall, and network quality diagnosis will be described with reference to FIGS. 8 to 10.

FIG. 8 is a flowchart illustrating an operation of an image forming apparatus and a diagnostic apparatus for diagnosing a network performance between the image forming apparatus and the diagnostic apparatus according to an example.

Referring to FIG. 8, an example is illustrated in which a network diagnosis packet is a network performance measurement packet including print data and information indicating that it is for network performance measurement. The example of FIG. 8 may illustrate a process of diagnosing the network performance. The information indicating that the network diagnosis packet is for network performance measurement may be in the form of a PJL command.

In operation 2110, the diagnostic apparatus 200 may receive a response packet in response to the network performance measurement packet transmitted to the print server port of the image forming apparatus 100. For example, the diagnostic apparatus 200 may transmit a connection request packet including the TCP 9100 port information and the IP address of the image forming apparatus 100 to the image forming apparatus 100 to establish a connection with the TCP 9100 port of the image forming apparatus 100. In the case of opening a separate network port to measure the network performance, the security level of the image forming apparatus 100 may be lowered due to the opening of the network port and the network port may be blocked by the firewall or the like and thus the network performance measurement may not be performed. Thus, without opening a separate network port, the network performance may be measured by using the TCP 9100 port that the image forming apparatus 100 uses to receive the print data. Upon completion of connection establishment with the image forming apparatus 100, the diagnostic apparatus 200 may transmit the network performance measurement packet generated by the diagnostic apparatus 200 to the TCP 9100 port of the image forming apparatus 100. The diagnostic apparatus 200 may receive a response packet in response to the transmission of the network performance measurement packet.

In operation 2210, the diagnostic apparatus 200 may determine the network performance between the image forming apparatus 100 and the diagnostic apparatus 200 based on the network performance information measured based on the received response packet and the reference network performance information corresponding to the image forming apparatus 100 stored in the diagnostic apparatus 200. The diagnostic apparatus 200 may measure the network performance information by measuring the amount of data transmitted to the image forming apparatus 100 and the time taken to transmit the data. The diagnostic apparatus 200 may determine whether the measured network performance has a problem in connecting and using the image forming apparatus 100, instead of determining the network performance based on only the measured network performance information. For this, the diagnostic apparatus 200 may acquire the reference network performance information corresponding to the image forming apparatus 100 from the reference network performance information database storing reference network performance information corresponding to each image forming apparatus model. The diagnostic apparatus 200 may have prestored therein the maximum network performance information for each model of the image forming apparatus 100. For example, when the image forming apparatus 100 has a low performance (e.g., below a threshold), it may be determined that there is no problem in using the network even when the network performance measured by the diagnostic apparatus 200 is somewhat low.

In operation 2310, the diagnostic apparatus 200 may provide a network performance report indicating whether the network performance is at a level suitable to use the image forming apparatus 100.

In response to the operation of the diagnostic apparatus 200, in operation 1110, the image forming apparatus 100 may receive the network performance measurement packet through the print server port. The image forming apparatus 100 may receive the connection request packet from the diagnostic apparatus 200, establish a connection with the TCP 9100 port of the image forming apparatus 100, and receive the network performance measurement packet through the TCP 9100 port. The image forming apparatus 100 may transmit, to the diagnostic apparatus 200, a response packet indicating that the network performance measurement packet has been received.

In operation 1210, the image forming apparatus 100 may determine the request of the diagnostic apparatus 200 according to information indicating that it is for network performance measurement, which is included in the received network performance measurement packet. For example, the image forming apparatus 100 may determine the request of the diagnostic apparatus 200 according to the type of the PJL command included in the received network performance measurement packet.

In operation 1310, the image forming apparatus 100 may delete the print data without performing an image forming operation on the print data in the case of being the information indicating that it is for network performance measurement and may perform an image forming operation on the print data in the case of not being the information indicating that it is for network performance measurement. For example, the image forming apparatus 100 may delete the print data without performing an image forming operation on the print data when the type of the PJL command is a PJL command for network performance measurement and may perform an image forming operation on the print data when the type of the PJL command is not a PJL command for network performance measurement.

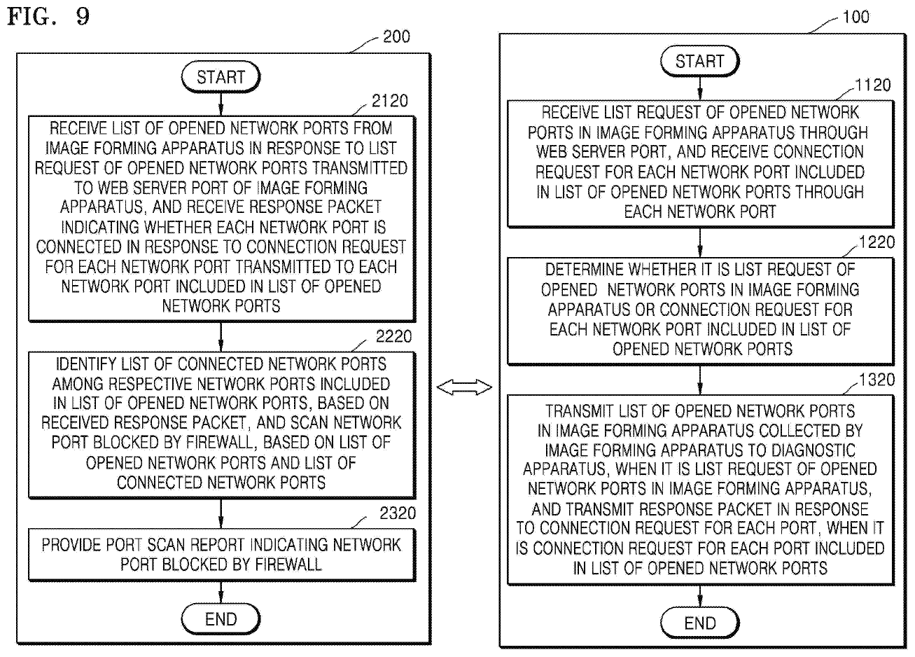

FIG. 9 is a flowchart illustrating an operation of an image forming apparatus and diagnostic apparatus for scanning a network port blocked by a firewall in a network between the image forming apparatus and the diagnostic apparatus according to an example.

Referring to FIG. 9, an example is illustrated in which a network diagnosis packet includes a list request of opened network ports in the image forming apparatus 100 or a connection request for each network port included in the list of opened network ports. The example of FIG. 9 may illustrate a process of scanning a network port blocked by the firewall. Network connection apparatuses such as a router, a switch, a firewall, and the like may be used for network communication between the image forming apparatus 100 and the diagnostic apparatus 200. However, the network connection apparatuses may discard or block a packet according to the security setting. The diagnostic apparatus 200 may scan the network port blocked by the firewall in order to determine whether the network port not connected in the image forming apparatus 100 should not be closed by the image forming apparatus 100 or has been blocked by the firewall.

In operation 2120, the diagnostic apparatus 200 may receive a list of opened network ports from the image forming apparatus 100 in response to the list request of opened network ports transmitted to the web server port of the image forming apparatus 100. The diagnostic apparatus 200 may receive a response packet indicating whether each network port is connected in response to the connection request for each network port transmitted to each network port included in the list of open network ports. For example, the diagnostic apparatus 200 may transmit a connection request packet including the TCP 80 port or TCP 431 port information and the IP address of the image forming apparatus 100 to the image forming apparatus 100 to establish a connection with the TCP 80 port or TCP 431 port of the image forming apparatus 100. Upon completion of connection establishment with the image forming apparatus 100, the diagnostic apparatus 200 may receive a list of opened network ports from the image forming apparatus 100 in response to the list request of opened network ports transmitted to the TCP 80 port or TCP 431 port. The diagnostic apparatus 200 may receive a response packet indicating whether each network port is connected in response to the connection request for each network port transmitted only to the opened network ports in the image forming apparatus 100.

In operation 2220, the diagnostic apparatus 200 may identify a list of connected network ports among the respective network ports included in the list of opened network ports, based on the received response packet and scan a network port blocked by the firewall, based on the list of opened network ports and the list of connected network ports. When the diagnostic apparatus 200 receives an inaccessible ICMP packet from the network or fails to receive a response packet from the image forming apparatus 100, the diagnostic apparatus 200 may determine that the network port is blocked by the firewall.

In operation 2320, the diagnostic apparatus 200 may provide a port scan report indicating the network port blocked by the firewall.

In response to the operation of the diagnostic apparatus 200, in operation 1120, the image forming apparatus 100 may receive a list request of opened network ports in the image forming apparatus 100 through the web server port. The image forming apparatus 100 may receive a connection request packet from the diagnostic apparatus 200, establish a connection with the TCP 80 port or TCP 431 port of the image forming apparatus 100, and receive a list request of opened network ports in the image forming apparatus 100 through the TCP 80 port or the TCP 431 port. The image forming apparatus 100 may receive a connection request for each network port included in the list of opened network ports through each network port.

In operation 1220, the image forming apparatus 100 may determine whether it is the list request of opened network ports in the image forming apparatus 100 or the connection request for each network port included in the list of opened network ports.

In operation 1320, in the case of being the list request of opened network ports in the image forming apparatus 100, the image forming apparatus 100 may transmit, to the diagnostic apparatus 200, the list of opened network ports in the image forming apparatus 100 collected by the image forming apparatus 100. In this case, the image forming apparatus 100 may collect additional information such as subnet information, gateway IP address information, link speed, wired/wireless connection of the image forming apparatus 100, and the like and transmit the same to the diagnostic apparatus 200. The image forming apparatus 100 may transmit a response packet in response to the connection request for each port in the case of being the connection request for each port included in the list of opened network ports.

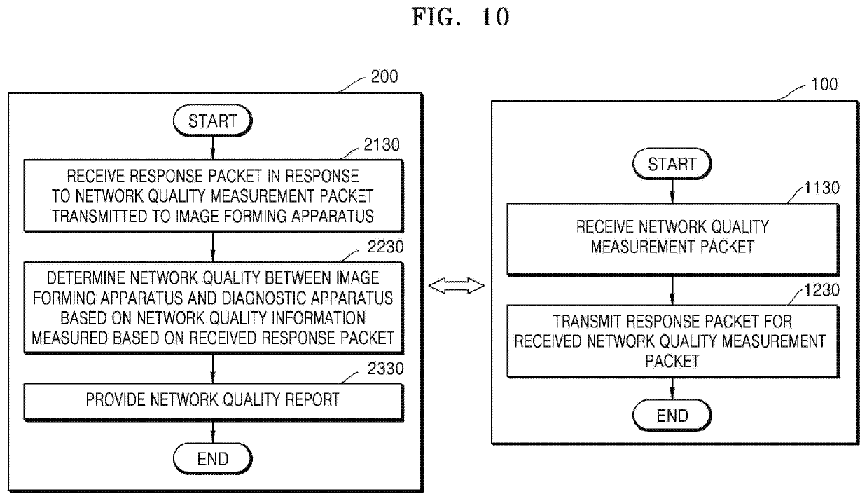

FIG. 10 is a flowchart illustrating an operation of an image forming apparatus and a diagnostic apparatus for diagnosing a network quality between the image forming apparatus and the diagnostic apparatus according to an example.

Referring to FIG. 10, an example is illustrated in which a network diagnosis packet is a network quality measurement packet, and may illustrate a process of diagnosing the network quality.

In operation 2130, the diagnostic apparatus 200 may receive a response packet in response to the network quality measurement packet transmitted to the image forming apparatus 100. The diagnostic apparatus 200 may generate a network quality measurement packet and transmit the generated network quality measurement packet to the image forming apparatus 100 repeatedly a certain number of times at certain periods. The network quality measurement packet may be in the same form as an ICMP request packet.

In operation 2230, the diagnostic apparatus 200 may determine the network quality between the image forming apparatus 100 and the diagnostic apparatus 200 based on the network quality information measured based on the received response packet. The diagnostic apparatus 200 may analyze the response packet received from the image forming apparatus 100 and measure network quality information such as a loss rate, a delay time, and the like.

In operation 2330, the diagnostic apparatus 200 may provide a network quality report.

In response to the operation of the diagnostic apparatus 200, in operation 1130, the image forming apparatus 100 may receive the network quality measurement packet.

In operation 1230, the image forming apparatus 100 may transmit a response packet to the diagnostic apparatus 200 in response to the received network quality measurement packet.

The above described examples may be implemented in the form of a program stored in a non-transitory computer-readable storage medium to cause the diagnostic apparatus 200 or the image forming apparatus 100 to perform the above operations. Also, the above described examples may be implemented in the form of a non-transitory computer-readable storage medium that stores instructions or data executable by a computer or a processor. It may be written as a program executable in a computer and may be implemented in a general-purpose digital computer that operates the program by using a computer-readable storage medium. The non-transitory computer-readable storage medium may be Read-Only Memory (ROM), Random-Access Memory (RAM), flash memory, Compact Disk Read-Only Memory (CD-ROM), Compact Disk Recordable (CD-R), CD+R, Compact Disk Rewritable (CD-RW), CD+RW, Digital Versatile Disk Read-Only Memory (DVD-ROM), Digital Versatile Disk Recordable (DVD-R), DVD+R, Digital Versatile Disk Rewritable (DVD-RW), DVD+RW, Digital Versatile Disk Random-Access Memory (DVD-RAM), Blu-ray Disk Read-Only Memory (BD-ROM), Blu-ray Disk Recordable (BD-R), Blu-ray Disk Recordable Low to High (BD-R LTH), Blu-ray Disk Recordable Erasable (BD-RE), magnetic tapes, floppy disks, magneto-optical data storages, optical data storages, hard disks, Solid-State Disks (SSDs), or any device that may store instructions or software, related data, data files, and data structures and may provide instructions or software, related data, data files, and data structures to a processor or computer to enable the processor or computer to execute instructions.

What is claimed is:

1. A diagnostic apparatus comprising:
a user interface device;
a communication interface;
a processor; and
a memory storing instructions executable by the processor, wherein the processor executes the instructions to:
receive, through the communication interface, a response packet in response to a network performance measurement packet transmitted to an image forming apparatus;
determine a network performance between the image forming apparatus and the diagnostic apparatus based on network performance information measured based on the received response packet and reference network performance information corresponding to the image forming apparatus; and
provide the determined network performance through the user interface device.

2. The diagnostic apparatus of claim 1, wherein the processor executes the instructions to transmit, through the communication interface to the image forming apparatus, the network performance measurement packet including print data and information indicating that a packet is for network performance measurement.

3. The diagnostic apparatus of claim 1, wherein the processor executes the instructions to transmit the network performance measurement packet to a print server port of the image forming apparatus through the communication interface.

4. The diagnostic apparatus of claim 1, wherein the processor executes the instructions to acquire the reference network performance information corresponding to the image forming apparatus from a reference network performance information database storing reference network performance information corresponding to each image forming apparatus model.

5. The diagnostic apparatus of claim 1, wherein the processor executes the instructions to provide, through the user interface device, a network performance report indicating whether the determined network performance is at a level suitable for use of the image forming apparatus.

6. A diagnostic apparatus comprising:
a communication interface;
a processor; and
a memory storing instructions executable by the processor,
wherein the processor executes the instructions to:
receive a list of opened network ports from an image forming apparatus in response to a list request of the opened network ports in the image forming apparatus transmitted to the image forming apparatus;
receive a response packet indicating whether each network port is connected in response to a connection request for each network port transmitted to each network port included in the list of opened network ports;
identify a list of connected network ports among respective network ports included in the list of opened network ports, based on the received response packet; and
scan a network port blocked by a firewall, based on the list of opened network ports and the list of connected network ports.

7. The diagnostic apparatus of claim 6, wherein the processor executes the instructions to:
transmit, through the communication interface, the list request of the opened network ports in the image forming apparatus to a web server port of the image forming apparatus; and
transmit the connection request for each network port only to an opened network port in the image forming apparatus identified in the list of opened network ports.

8. The diagnostic apparatus of claim 6, further comprising a user interface device,
wherein the processor executes the instructions to provide, through the user interface device, a port scan report indicating the network port blocked by the firewall.

9. A non-transitory computer-readable storage medium encoded with instructions executable by a processor, the non-transitory computer-readable storage medium comprising:
instructions to receive a response packet in response to a network performance measurement packet transmitted to an image forming apparatus;
instructions to determine a network performance between the image forming apparatus and the diagnostic apparatus based on network performance information measured based on the received response packet and reference network performance information corresponding to the image forming apparatus; and
instructions to provide the determined network performance.

10. The non-transitory computer-readable storage medium of claim 9, wherein the instructions to receive comprise instructions to receive the response packet in response to the transmission of the network performance measurement packet including print data and information indicating that a packet is for network performance measurement.

11. The non-transitory computer-readable storage medium of claim 9, wherein the instructions to receive comprise instructions to receive the response packet in response to the network performance measurement packet transmitted to a print server port of the image forming apparatus.

12. The non-transitory computer-readable storage medium of claim 9, wherein the instructions to determine the network performance comprise instructions to acquire the reference network performance information corresponding to the image forming apparatus from a reference network performance information database storing reference network performance information corresponding to each image forming apparatus model.

13. The non-transitory computer-readable storage medium of claim 9, wherein the instructions to provide the determined network performance comprise instructions to provide a network performance report indicating whether the determined network performance is at a level suitable to use the image forming apparatus.

14. A non-transitory computer-readable storage medium encoded with instructions executable by a processor, the non-transitory computer-readable storage medium comprising:
instructions to receive a list of opened network ports from an image forming apparatus in response to a list request of the opened network ports in the image forming apparatus transmitted to the image forming apparatus;
instructions to receive a response packet indicating whether each network port is connected in response to a connection request for each network port transmitted to each network port included in the list of opened network ports;
instructions to identify a list of connected network ports among respective network ports included in the list of opened network ports, based on the received response packet; and
instructions to scan a network port blocked by a firewall, based on the list of opened network ports and the list of connected network ports.

15. The non-transitory computer-readable storage medium of claim 14,
wherein the instructions to receive the list of opened network ports comprise instructions to receive the list of opened network ports in response to the list request of the opened network ports in the image forming apparatus transmitted to a web server port of the image forming apparatus, and
wherein the instructions to receive the response packet comprise instructions to receive the response packet in response to the connection request for each network port transmitted only to an opened network port in the image forming apparatus identified in the list of opened network ports.
